(19) United States
(12) Patent Application Publication
(10) Pub. No.: US 2004/0203363 A1
(43) Pub. Date: Oct. 14, 2004

(54) Portable communication apparatus and method for match-making with unique user ID

(76) Inventors: Stephen J. Carlton, Raleigh, NC (US); Olle Bliding, Haverdal (SE); Jonas Runesson, Halmstad (SE); Anna Emanuelsson, Halmstad (SE); Lars Knutsson, Halmstad (SE)

Correspondence Address: Finnegan, Henderson, Farabow,, Garrett & Dunner, L.L.P., 1300 I Street, N.W., Washington, DC, 20005-3315, US

(21) Appl. No.: 10/125,461

(22) Filed: Apr. 19, 2002

(51) Int. Cl. H04B 7/00

(52) U.S. Cl. 455/41.2; 455/517; 455/414.1

(57) ABSTRACT

A portable communication apparatus for match-making with a plurality of remote communication apparatuses has memory means for storing first match-making data associated with the portable communication apparatus. The portable communication apparatus also has a transceiver for communication with an individual one of the remote communication apparatuses across a wireless link, so as to receive second match-making data associated with the individual remote communication apparatus. The wireless link is based on an apparatus-specific identity of the port able communication apparatus as well an apparatus-specific identity of the individual remote communication apparatus. The portable communication apparatus further has a processing device for performing a correlation analysis between the first match-making data and the second match-making data and—in case a result of the correlation analysis indicates a match between the portable communication apparatus and the individual remote communication apparatus—providing an alert to a user of the portable communication apparatus. The apparatus-specific identity of the portable communication apparatus, the apparatus-specific identity of the individual remote communication apparatus as well as the apparatus-specific identities of other ones of the remote communication apparatuses are all unique.

### FIELD OF THE INVENTION

Generally speaking, the present invention relates to electronic match-making. More specifically, the present invention concerns a portable communication apparatus for match-making with a plurality of remote communication apparatuses. The invention also concerns a power preservation method for such an apparatus.

### BACKGROUND OF THE INVENTION

In general, match-making refers to a procedure of determining whether the properties of two objects have a degree of correspondence which is sufficient to qualify as a match between the two objects. One area where match-making is applicable is dating, i.e. the process of pairing together two persons, both of which seek friendship, partnership, a business relation, etc. To this end, match-making information will be exchanged between the two persons, they will both perform a correlation analysis between their own information and the received information, and then usually they will have a feeling whether there is a match between them or not. Depending on the dating situation the exchange of information will be performed in different ways. For example, a traditional approach is when one of the persons inserts a personal advertisement in a newspaper or on the internet, and the other person replies to it. The exchange of information is then usually made by writing letters or e-mails. Another example is the situation where the two persons meet in a coffee shop or a nightclub. The exchange of information is then simply made by talking.

A problem with the above dating methods, and conventional dating in general, is the considerable risk that two partly randomly chosen persons will not match. Not seldom, it takes considerable time before two persons realize that they do not match. If the dates are not supposed to be like quizzes, it will take time for two persons to know enough about each other to tell a match from a mismatch. Therefore, finding the right partner can be very difficult and also very time consuming, since one probably will have to date a number of different persons before one finds the ideal partner.

From U.S. Pat. Nos. 4,348,740, 4,348,744 to White, a method and an apparatus for comparison of sets of personal data are known. Users can enter data about themselves in these portable apparatuses and then compare their data by physically interconnecting the apparatuses by means of electrical connectors. Scores representing the compatibilities between users are shown on the apparatuses.

From German patent application DE 197 35 045 an information handling unit for comparing personality profiles is known. Like in the White invention above, users physically interconnect their apparatuses to compare stored data. Two interconnected units signal if there is a match between their users.

These known apparatuses have major disadvantages, one of which is that users have to carry their apparatuses in full view to be able to find each other, meaning that everybody else can see who is carrying such an apparatus. Another disadvantage is that users have to be very active and search for other users, because of the restricted operational range which is due to the physical interconnection technique. Additionally, when two users have seen each other, if they find each other interesting, they will have to make eye-to-eye contact in order to be able to compare their information, an indiscrete situation which in many ways can be very uncomfortable.

An improved apparatus is known from U.S. Pat. No. 6,150,937 to Rackman, disclosing a personal contact “Ice Breaker” badge which operates wirelessly by means of radio frequency (RF) communication. One type of contact badges are distributed to the boys in a group and another type to the girls in the group. All badges are provided with a light that can blink, and opposite badges in proximity with each other transmit and receive RF contact signals. If the lights on two badges blink at the same time, the carriers of the badges should start talking to each other. Whether this happens or not is based at least partly on probability, and the blinking is therefore no precise indication of a match between the carriers.

A somewhat similar apparatus and method for finding a date/mate is known from U.S. Pat. No. 6,020,810 to Har-Even. A user enters personal data into his/her apparatus. The data is transmitted to, and other data is received from, another apparatus by way of RF communication. The received and the transmitted data are compared, and a percentage match between them is determined. An alarm is activated if the percentage match is greater than a predetermined value.

From German patent DE 44 18 234 a unit similar to the Har-Even apparatus is known. Data entered by a user is transmitted to, and other data is received from, another unit through RF communication. If there is a mutual match between two units, their users will be alerted.

The present inventors have observed the following remaining problems with the prior art apparatuses briefly described above.

First of all, the prior art apparatuses are not designed to handle situations where not just two match-making apparatuses but a plurality of such apparatuses are concurrently present within a limited area and where, consequently, more than one pair of apparatuses may need to communicate simultaneously.

Moreover, the prior art apparatuses handle the actual match-making, but they do not give any support for subsequent actions that are often triggered by a successful match, such as introductory discussions, suggestions for meeting activities, etc.

Additionally, the prior art apparatuses are portable and battery-powered, and have a number of components—such as radio transceiver, processor and display—with a considerable power consumption in total, but no measures are provided for minimizing the power consumption.

Furthermore, the prior art apparatuses do not provide any protection against abuse. What if an annoying or even criminal individual would get hold of a match-making apparatus and keep on harassing innocent people? If harassed once, you would at least want to prevent further harassments from that individual.

On the other hand, there may be other individuals, the presence of which you would like to be informed of once they are within the operational range of your match-making apparatus. Examples of such preferred individuals may be established friends, relatives, or people that you have had a successful match with earlier.

### SUMMARY OF THE INVENTION

In view of the above, the invention seeks to provide a solution or at least an improvement to the problems discussed above.

Generally, the above objectives are achieved by an apparatus and a method according to the attached independent patent claims.

Thus, a first aspect of the invention is a portable communication apparatus for match-making with a plurality of remote communication apparatuses, said portable communication apparatus comprising:

memory means, wherein said memory means is adapted to store first match-making data associated with said portable communication apparatus;

a transceiver, wherein said transceiver is adapted for communication with an individual one of said remote communication apparatuses across a wireless link, so as to receive second match-making data associated with said individual remote communication apparatus, said wireless link being based on an apparatus-specific identity of said portable communication apparatus as well an apparatus-specific identity of said individual remote communication apparatus;

a processing device, wherein said processing device is adapted to perform a correlation analysis between said first match-making data and said second match-making data and—in case a result of said correlation analysis indicates a match between said portable communication apparatus and said individual remote communication apparatus—provide an alert to a user of said portable communication apparatus;

wherein the apparatus-specific identity of said portable communication apparatus, the apparatus-specific identity of said individual remote communication apparatus as well as the apparatus-specific identities of other ones of said remote communication apparatuses are all unique.

A second aspect of the invention is a power preservation method for a portable communication apparatus according to the above, comprising the steps of transmitting, through said transceiver, inquiries for remote apparatuses within reach;

receiving responses from remote apparatuses which have received said inquiries;

evaluating the number of responses received; and

in response to said evaluating step, adjusting at least one of a duration of said transmitting step, a time interval between subsequent transmitting steps, and an output power of said transceiver.

The power preservation method according to the second aspect may be used to optimize the power consumption of a portable communication apparatus according to the first aspect and, therefore, to allow longer operational time between successive battery recharges or replacements. In addition, the power preservation method according to the second aspect may assist in reducing the disturbances caused upon other neighboring apparatuses. A portable communication apparatus according to the first aspect may however be embodied without any power preservation method according to the second aspect.

Other objectives, features and advantages of the present invention will appear from the following detailed disclosure, from the attached dependent claims as well as from the drawings.

### BRIEF DESCRIPTION OF THE DRAWINGS

A preferred embodiment of the present invention will now be described in more detail, reference being made to the enclosed drawings, in which:

FIGS. 1a, 1b and 1c is a perspective view, a top view and a side view, respectively, of a portable communication apparatus according to one embodiment of the present invention;

FIG. 2 is a schematic illustration of a practical use scenario, where a plurality of portable communication apparatuses are used for match-making between respective users;

FIG. 3 is a schematic hardware block diagram for the apparatus shown in FIG. 1;

FIG. 4 is a schematic block diagram, which illustrates three major portions of the software in the apparatus shown in FIG. 1;

FIG. 5 is a detailed block diagram, which illustrates different modules of a base software portion shown in FIG. 4;

FIG. 6 illustrates how the base software portion shown in FIG. 5 interacts with an application software portion shown in FIG. 4 through an event queue;

FIG. 7 is a flowchart diagram to illustrate the general event management of the application software portion shown in FIG. 4;

FIG. 8 is a detailed block diagram, which illustrates different modules of the application software portion shown in FIG. 4;

FIG. 9 illustrates the operation of one module in FIG. 8, a keyboard event handler;

FIG. 10 is a flowchart diagram to illustrate a method of handling inquiries according to a preferred embodiment;

FIG. 11 is a flowchart diagram to illustrate a power management method according to a preferred embodiment;

FIG. 12 illustrates a plurality of match-making parameters together with respective possible values thereof;

FIG. 13 illustrates a data format for exchange of match-making information between different apparatuses of FIG. 2; and

FIG. 14 illustrates a set of lists, which keep track of different apparatuses of FIG. 2 and are stored in different memories of the apparatus shown in FIG. 1.

### DETAILED DISCLOSURE OF EMBODIMENTS

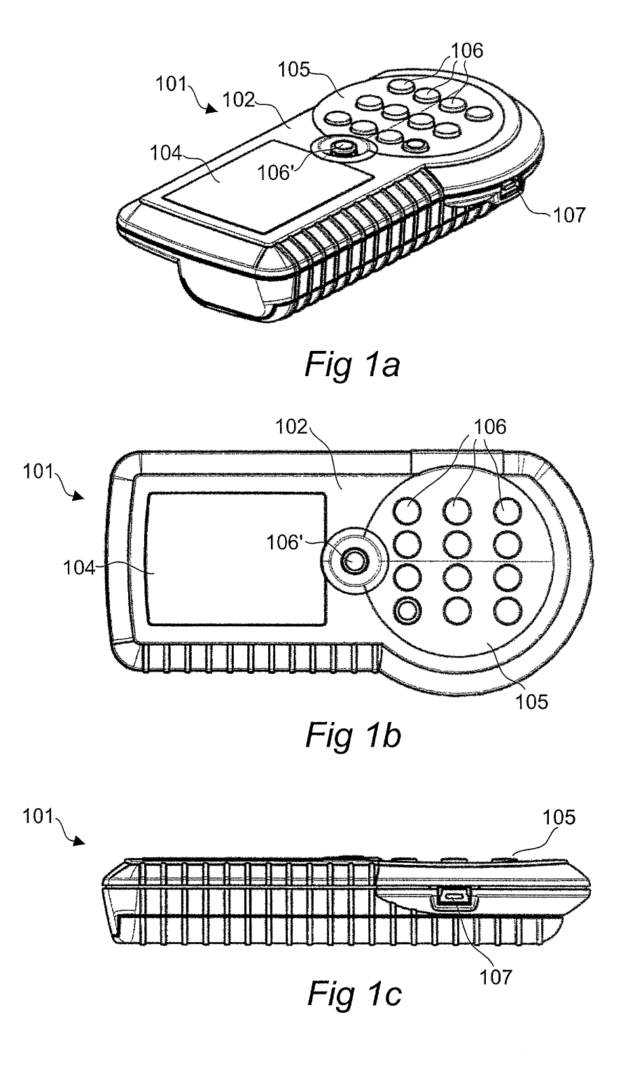

Initially, an overview of the functional features of the portable communication apparatus according to a preferred embodiment of the present invention will be given with reference to FIGS. 1a-c and 2. Then, a detailed description of the structural features will follow with reference to the remaining FIGS.

FIGS. 1a-1c show a portable communication apparatus 101 according to a preferred embodiment. The portable communication apparatus 101 is a wireless match-making device, assisting a user of the portable communication apparatus in meeting other people, each equipped with a respective portable communication apparatus of the same, or similar, type as apparatus 101.

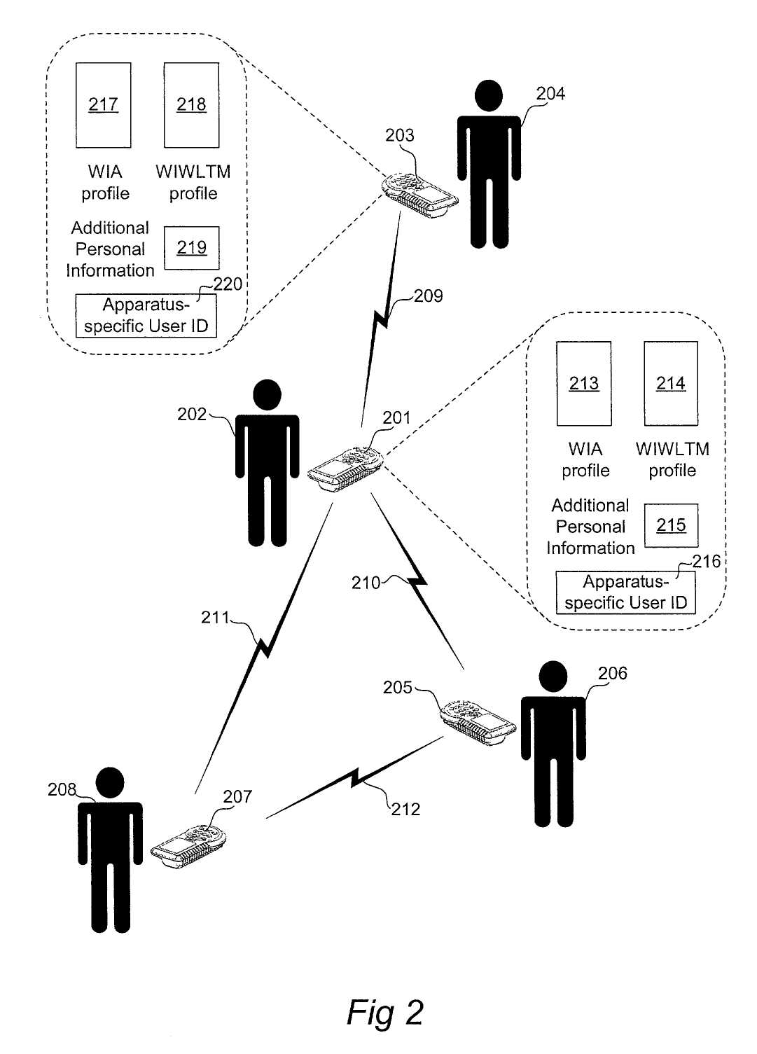

A use scenario is illustrated in FIG. 2. A plurality of users 202, 204, 206, 208 are provided with portable communication apparatuses 201, 203, 205, 207. As will be described in more detail later, these multiple apparatuses 201, 203, 205, 207 will establish short-range wireless links 209, 210, 211, 212 between each other, exchange profile information, perform a correlation analysis and alert the users when matches occur, all in an ad-hoc manner without the users' interaction, active involvement or knowledge.

To this end, each user 202, 204, 206, 208 will initially complete a first profile about himself/herself, referred to as a “Who I am” profile, and a second profile about the person that the user wishes to find, referred to as a “Who I would like to meet” profile. These profiles are stored locally in the apparatuses 201, 203, 205, 207. More specifically, the profiles 213, 214 that are associated with user 202 of apparatus 201 are stored locally in this apparatus 201, whereas the profiles 217, 218 that are associated with user 204 are stored locally in apparatus 203, etc.

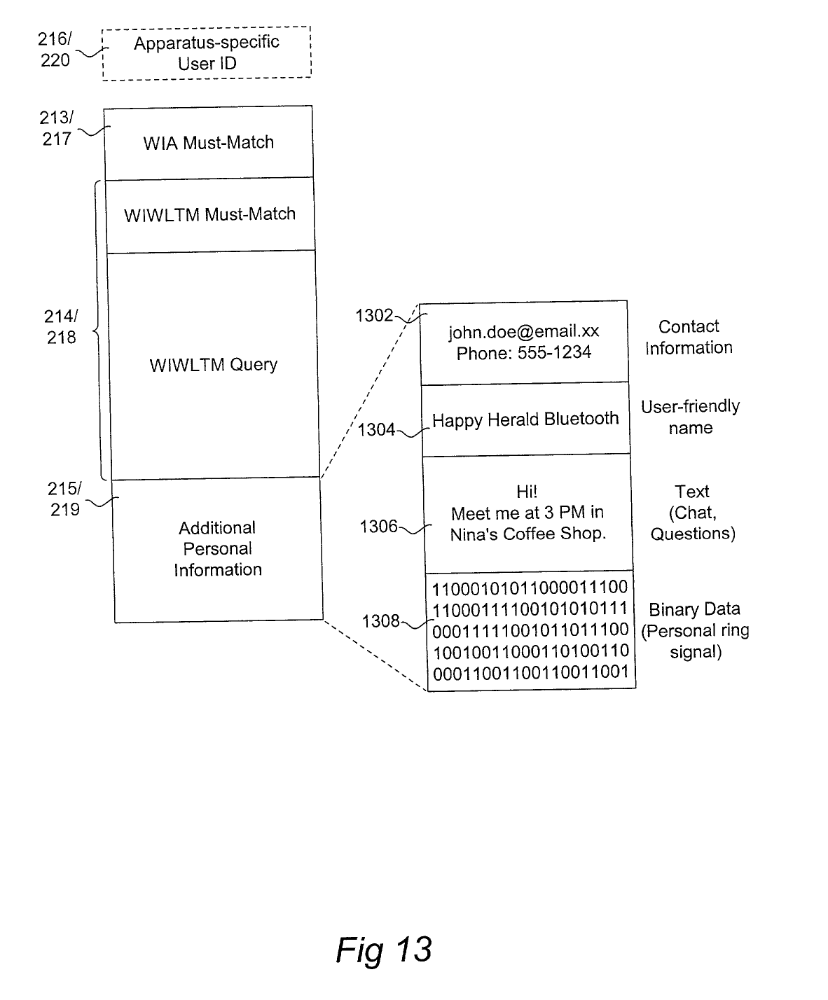

In operation, any of the apparatuses 201, 203, 205, 207, for instance apparatus 201, will then detect, without the knowledge of either the sending or receiving party, when other apparatuses 203, 205, 207 are within the same short-range area and, upon recognition, exchange encrypted and confidential profile information to any and all of these other apparatuses across the wireless links 209, 210, 211, 212. Associated with the sender's “Who I would like to meet” profile is additional personal information 215, 219 and a unique apparatus-specific user-ID 216, 220, both of which are also stored locally in the apparatuses 201, 203, 205, 207. As is illustrated in more detail in FIG. 13, the additional personal information 215, 219 relates to personal particulars about the sender, such as contact information 1302 in the form of an email address, a mobile phone number, a university campus address, a school locker number, a hotel name and a room number, description of clothing, etc. The additional personal information 215, 219 may also include a user-friendly name 1304, a text message 1306 and/or binary data 1308 such as a personal ring signal, which in combination with the unique apparatus-specific user-ID 216, 220 will allow several services and features which are advantageous over the prior art, as will be described later.

On the receiving end, each apparatus will perform a correlation analysis between the incoming “Who I would like to meet” profile and the receiver's own “Who I am” profile. If the correlation or percent match between the two profiles meets or exceeds a user pre-set matching level, the original sender's additional personal information and apparatus-specific user-ID will be stored in memory. The receiver's apparatus will also alert the owner of this exciting new match by visual, acoustical or tactile means.

Typically, the wireless operating range of the apparatuses is 10-100 m, and since the apparatuses are carried by mobile—typically walking—users, the number of other apparatuses 203, 205, 207 that are within range of each apparatus 201 will vary from time to time. Thus, the situation in FIG. 2 represents an exemplifying and momentary view only.

In addition to the match-making described above, the portable communication apparatus 101 according to the preferred embodiment provides several other services, which are all based on the unique apparatus-specific user-ID 216, 220 of each apparatus 201, 203, 205, 207. Firstly, without going through a commercial mobile telecommunications network, a public service telephone network (PSTN) or a wide area network such as Internet, the users 202, 204, 206, 208 will be able to send and receive text messages, free of charge, between their apparatuses 201, 203, 205, 207. Once each apparatus-specific user-ID is known and any two apparatuses are within range of each other, the users of these apparatuses can perform encrypted instant text communication between each other—to some extent similar to commercial SMS, email and chat services.

This feature can also be used for asking and replying to questions in a broadcast manner. Again, without going through an existing commercial network and free of charge, users will be able to send any text-based question to all apparatuses which are presently in range or come into range. Apparatuses that receive these text-based questions can then respond to the sender, either via the contact information 1302 included in the sender's additional personal information 215, 219 or, if still in range, directly via a text message reply 1306 included in the additional personal information 215, 219 and addressed to the sender's apparatus-specific user-ID.

Pre-programmed with for instance a friend's or family member's unique user-ID, the portable communication apparatus 101 may (at the discretion of the user) actively search on its own for any and all other portable communication apparatuses and give an alert to the user, once the friend or family member is in range. This feature is particularly useful in large crowded places, where the presence of friends and loved ones may not be visually apparent. Of course, more than one apparatus-specific user-ID may be added to such a “Buddy list”.

A similar feature is referred to as a “Blocked list”, which allows the user to pre-program a number of apparatus-specific user-ID's, for which communication is to be prohibited, in case they appear within range of the portable communication apparatus 101. Thus, thanks to this Blocked list, abusive or criminal individuals may be prevented from harassing the user of the portable communication apparatus 101, as regards match-making as well as follow-up services such as transmission of text messages or questions.

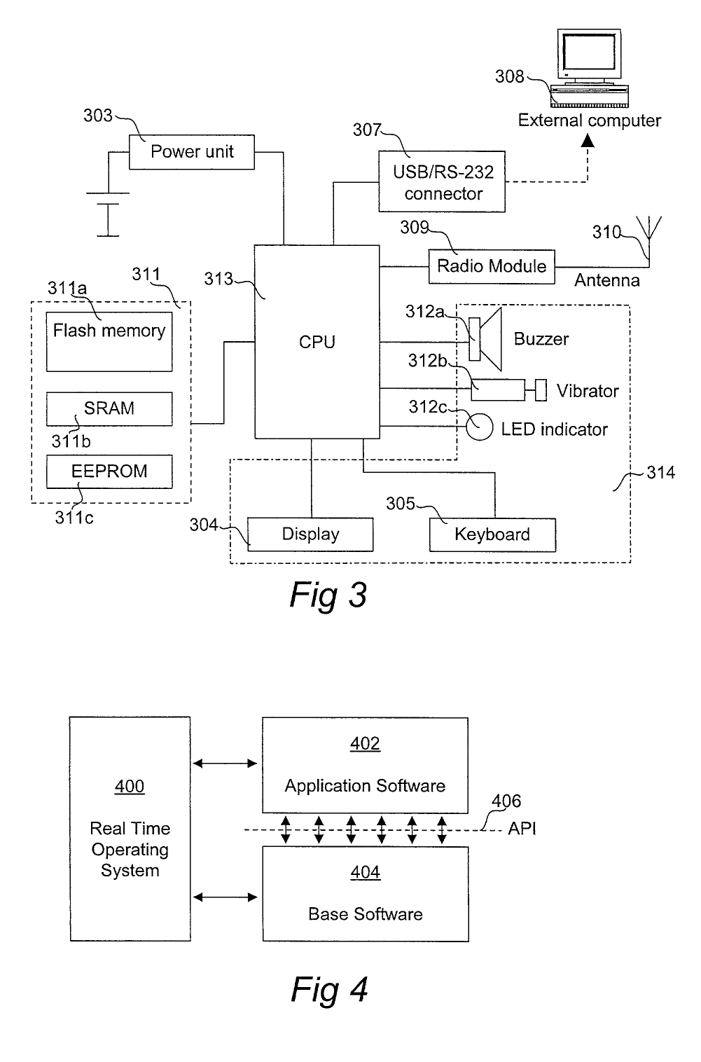

The particulars of the portable communication apparatus 101 will now be described with reference to FIGS. 1a-c, which show the externally visible components, as well as FIG. 3, which is a block diagram schematically illustrating the hardware components of the portable communication apparatus 101 and disclosing its internal structure.

The portable communication apparatus 101 comprises a casing 102, which is small enough for the portable communication apparatus to be held in one hand or carried in, for example, a pocket or a handbag. The casing can have a number of different designs when it comes to shape, colors etc., and it is preferably removable allowing a user to change the appearance of his/her portable communication apparatus by replacing the casing with another one. Advantageously, the casing has a design which resembles a contemporary, miniaturized mobile telephone, PDA (portable/pocket digital assistant), video game controller, etc. A power unit 303 accommodating four batteries, preferably rechargeable ones, is arranged inside the casing 102.

Furthermore, the apparatus 101 comprises a display 104, 304 for interaction with the user of the portable communication apparatus. In standby mode, the display may, for example, indicate the remaining power level for the power unit 303, the time and date, as well as various graphical elements such as icons, buttons and dialog boxes which emanate from the application software.

The portable communication apparatus also has a keyboard 105, 305, allowing the user to operate the portable communication apparatus 101 through a number of keys 106 and a joystick 106′. According to the preferred embodiment, the keyboard 105, 305 has a design in similar with a contemporary mobile phone, i.e. the keys 106 represent a number of symbols, such as digits and/or characters. In addition to the keyboard 105, 305, the portable communication apparatus 101 has a connector 107, 307 for connecting the portable communication apparatus to an external computer 308.

For wireless data exchange with any available portable communication apparatus (such as apparatus 203, 205 or 207 in FIG. 2), the portable communication apparatus 101 comprises a radio module 309. In the preferred embodiment the radio module 309 is a transceiver which is adapted for short-range radio communication in accordance with the Bluetooth™ specification in the 2.4 GHz ISM band (“Industrial, Scientific and Medical”). For details about the Bluetooth specification, reference is made to the Bluetooth Core Specification (also known as Bluetooth Specification, Volume I) and the Bluetooth Profiles Definition (also known as Bluetooth Specification, Volume II), both of which are available at http://www.bluetooth.com/. The portable communication apparatus 101 also has an antenna 310 through which Blue-tooth radio communication with the other portable communication apparatuses is performed. In the preferred embodiment the transceiver 309 and the antenna 310 have an operating range of about 10-100 m, although the range can vary due to environmental conditions, and the exact values are not critical to the invention.

In the preferred embodiment, the aforesaid unique apparatus-specific user-ID 216 of the portable communication apparatus 101/201 is formed by a 48-bit Bluetooth address (known as BD address in the Bluetooth specification), which is associated with the individual Bluetooth transceiver 309.

In alternative embodiments the transceiver can instead be adapted for another type of radio interface, or infrared communication (such as IrDA—“Infrared Data Association”), or essentially any other available standard for short-range communication between a hand-held apparatus and an external apparatus.

For the storing of information in the portable communication apparatus 101, i.e. information needed for the function of the portable communication apparatus, such as program code and static data, information entered by the user of the portable communication apparatus, and information received from remote portable communication apparatuses according to the invention, the portable communication apparatus 101 comprises memory means 311.

Additionally, for further interaction with the user, the portable communication apparatus 101 has alerting means such as a buzzer 312a for emitting ring tones, a vibrator 312b for a more discrete alerting and an LED 312c for emitting light. The display 304 and the keyboard 305 together with these alerting means jointly form a user interface 314.

Finally, a CPU 313 in the portable communication apparatus 101 controls the operations of the portable communication apparatus.

Before information is exchanged with another portable communication apparatus, the information is advantageously but not necessarily encrypted to increase the safety and privacy for users. Therefore, the portable communication apparatus 101 may comprise encryption and decryption means for encrypting information prior to transmission, and decrypting information after reception. The encryption means advantageously operates according to any data encryption algorithm known per se, such as an asymmetric algorithm like RSA, or a symmetric algorithm like DES. The preferred embodiment uses a data encryption algorithm commonly known as SAFER+. The decryption means will operate in accordance with the corresponding data decryption algorithm. Advantageously, the encryption and decryption means are implemented as software modules stored in the memory means 311 and executed by the CPU 313, or alternatively as hardware.

A selection of components will now be described in more detail for the preferred embodiment. It is to be understood, however, that this selection is in no way limiting to the invention; various other commercially available components may be chosen in place of the ones disclosed, as is readily realized by a skilled person.

The transceiver 309 is a BiCMOS class 1 Bluetooth radio module, which is of type PBA31302/1 and is available from Ericsson Microelectronics AB, Isafjordgatan 16, SE-164 81 Kista, Sweden. It provides fast frequency hopping, with 1600 channel hops per second, using 79 channels between 2.402 and 2.480 GHz, and allowing a maximum bit rate of 1 Mbit/s. The radio module has a 13 MHz reference frequency crystal, which is available from Taitien Electronics Co., Ltd, 5 Fl. 76, Po Ai Road, Taipei, Taiwan 100.

The selection of the antenna 310 will depend on the design of the casing 102 as well as its desired size, format and flexibility. In the preferred embodiment, an ICM antenna which fits to the inside of the casing is selected. The ICM antenna is available from gigaAnt, Ideon Science & Technology Park, Ole Römers väg 16, SE-223 70 Lund, Sweden. Alternatively, a Flavus/Crispus antenna from the same company may be used.

The CPU 313 is a Bluetooth baseband processor of type PBM99090/1, which is available from Ericsson Microelectronics AB. It uses a clock frequency derived from the radio clock signal and includes an ARM7 RISC (12-40 MHz), which provides adequate performance for the functionality of the apparatus 101. The baseband processor has a 64 KB internal RAM memory and handles communication protocols (Bluetooth embedded stack ver 1.00) as well as the higher-level functionality of the apparatus 101, as described throughout this document.

The memory means 311 associated with the CPU 313 consists of a 1 MB flash memory 311a, a 512 KB external static RAM (SRAM) memory 311b and a serial 32 KB EEPROM memory 311c, wherein the latter acts as a scratch-pad memory for the functionality provided by the apparatus 101. The flash memory 311a is of type BGA48, which is available from Silicon Storage Technology, Inc., 1171 Sonora Court, Sunnyvale, Calif. 94086, U.S.A., under article number SST39VF800A-70-4C-B3K. The SRAM memory 311b is of type BA48B and is available from Cypress Semiconductor Corporation, 3901 North First Street, San Jose, Calif. 95134, U.S.A., under article number CY62147CV25LL-70BAI. The EEPROM memory 311c is of type SOIC-8 and is available from Atmel Corporation, 2325 Orchard Parkway, San Jose, Calif. 95131, U.S.A., under article number AT24C256N-10SC-2.7.

The connector 307 provides a serial interface to the external computer 308 and comprises, in the preferred embodiment, an RS232 interface as well as a USB interface, both of which are supported by the baseband processor. USB provides the most user-friendly interface, is faster and has the cheapest hardware. It also makes it possible to power/charge the apparatus 101 while connected, as USB also provides power through its communication cable.

RS232, on the other hand, does not provide power. Thus, in that case charging has to be done through the power unit 303. The power unit 303 comprises four AAA battery cells connected in series with each other, and a step-down converter, which is of type MAX1724EZK27-T and is available from Maxim Integrated Products, Inc., 120 San Gabriel Drive, Sunnyvale, Calif. 94086, U.S.A.. The battery cells may be of rechargeable type and may receive charging power from either an internal or an external AC/DC converter. Some embodiments of the invention may use battery technologies known from the field of mobile telephones, such as Li ion, Li polymer, NiMH or NiCd batteries.

In alternative embodiments, the communication between the external computer 308 and the portable communication apparatus 101 may be performed wirelessly, i.e. the connector 307 is replaced by a wireless interface such as IrDA or, in fact, Bluetooth.

The display 304 is a 64×128 LCD module of type WD-G1206Y-1WNNa, which is available from Wintek Corporation, 427 North Sixth Street, Lafayette, Ind. 47901-1126, U.S.A.

The buzzer 312a is a MQT-03EX buzzer from Star Micronics Co., Ltd, 20-10, Nakayoshida, Shizuoka 422-8654, Japan.

The vibrator 312b and the LED indicator 312c may be selected from various appropriate available component manufacturers.

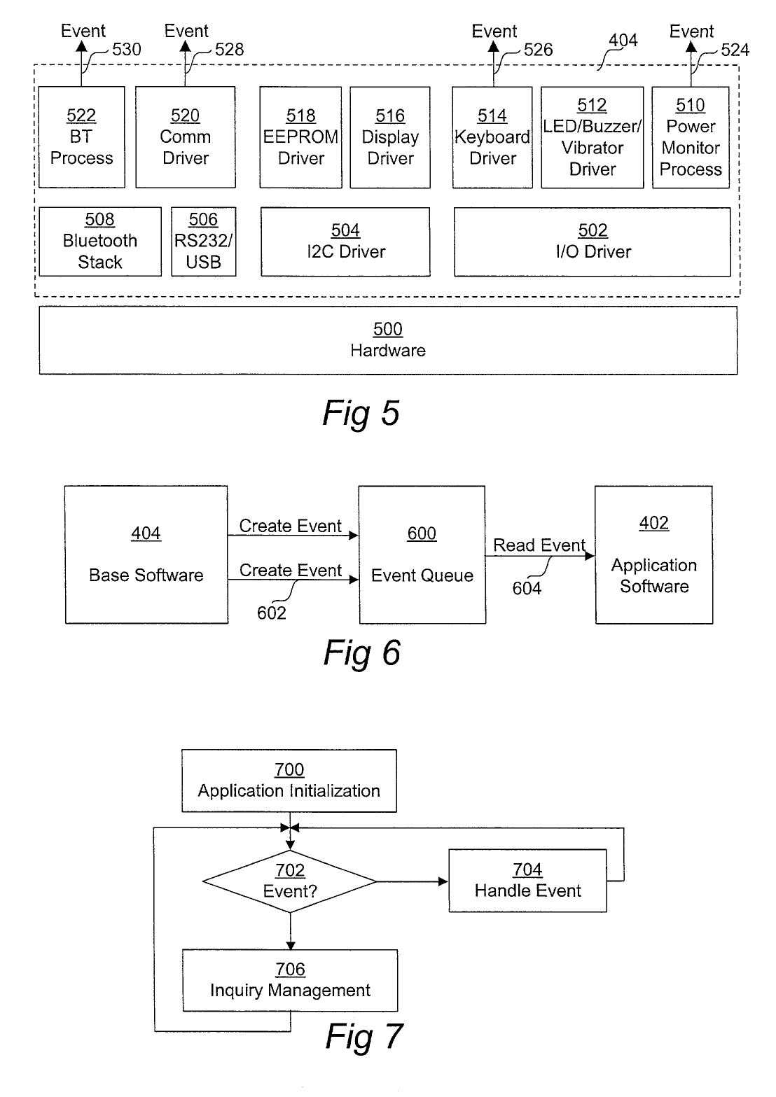

As seen in FIG. 4, the software of the preferred embodiment of the portable communication apparatus 101 is divided into three major sub systems: an application software portion 402, a base software portion 404 and a Real Time Operating System 400. The operating system 400 is OSE, which supports multitasking and provides high real time performance. A predefined application programming interface (API) 406 is provided between the application software 402 and the base software 404. The application software includes various segments of program code, which when executed by the CPU 313 will implement all the necessary functionality of the portable communication apparatus 101. The base software provides supportive base functionality and hardware-dependent functionality such as device drivers, as is illustrated in more detail in FIG. 5.

The application software 402 generally operates in an event-driven manner upon user events generated by the base software 404, for instance (FIG. 5) keyboard events 526, Bluetooth events 530 indicating actions from other portable communication apparatuses, serial communication events 528 associated with the external computer 308, and system events such as power monitor events 524 indicative of a battery status of the power unit 303. As seen in FIG. 6, the base software will generate events, at 602, and insert them into a main event queue 600, from which the application software 402 will read events at 604.

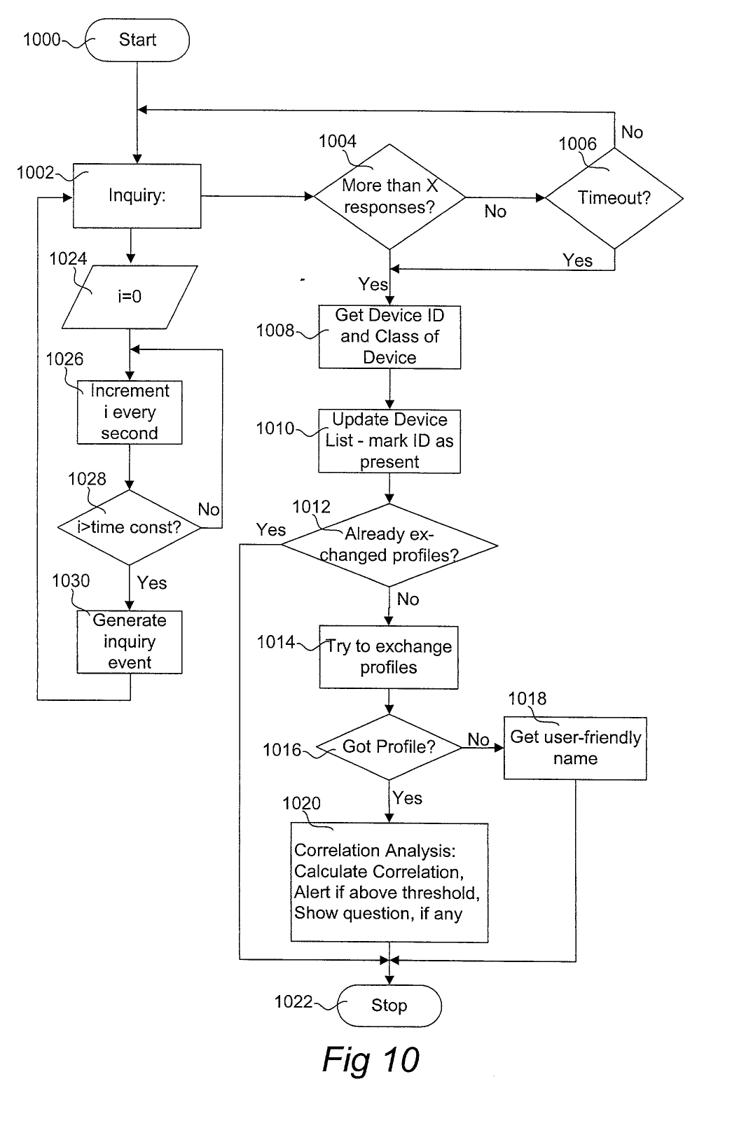

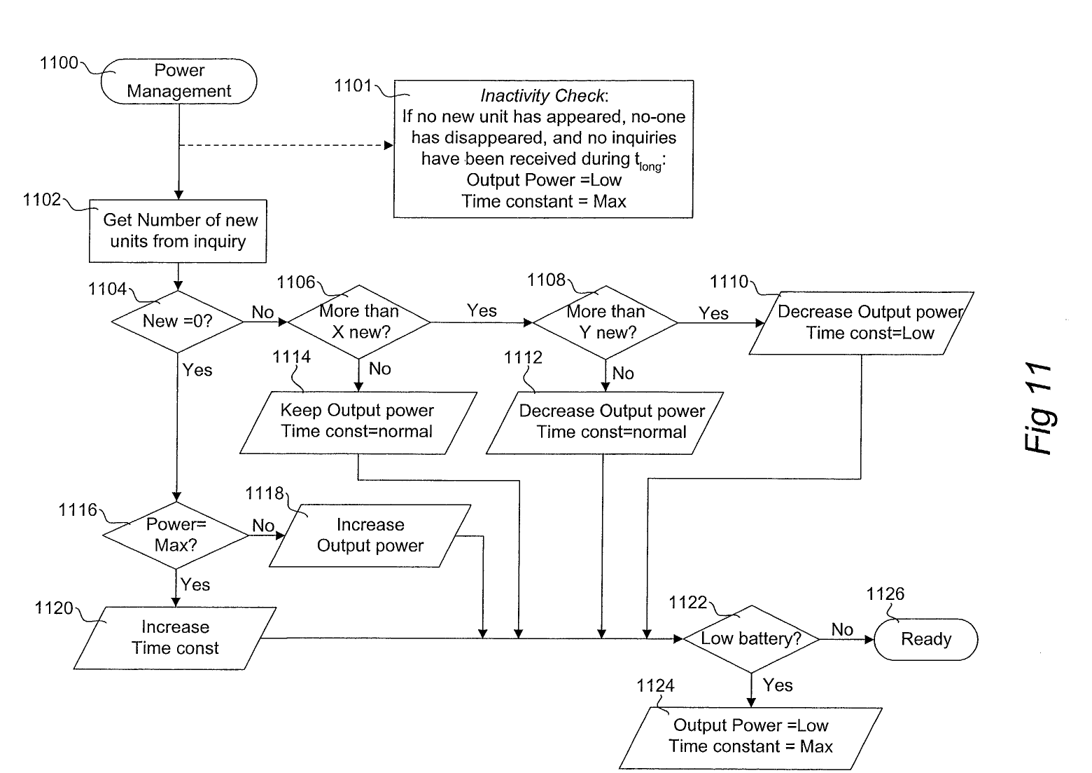

As seen in FIG. 7, once the application software 402 has been initialized at 700, it will poll the event queue 600 in an endless loop. If an event is found to be available at 702, the event will be handled at 704 and deleted from the queue. If, on the other hand, there is no event available in the event queue 600, the application software 402 will perform inquiry management 706—which is illustrated in more detail in FIGS. 10 and 11—and the loop will again poll for a new event at 702.

Depending on the type of event the application software 402 will take different actions at 704 and enter different operating modes. The main event types are:

| Event type | Description |
|---|---|
| Keyboard event | A key has been pressed, and the key code |
| | is given within the event message. |
| Bluetooth event | A Bluetooth event has occured, and the |
| | sub-event is given within the event |
| | message. |
| Power event | An event generated by a battery power |
| | monitoring process. |
| Error event | An error event caused by the base |
| | software, indicating some sort of |
| | malfunction in the apparatus 101. |
| Host event | The apparatus 101 has been alerted by |
| | the external computer 308 via |
| | RS232/USB/Bluetooth. |

The base software 404 provides various services to the application software 402, such as Bluetooth functionality, keyboard interface, display interface, non-volatile memory interface and serial communication interface. To this end, the base software has a first layer which directly interfaces the hardware 500. As seen in FIG. 5, the first layer includes an I/O driver 502, an I2C driver 504, an RS232/USB driver 506 and a Bluetooth stack 508.

The latter is implemented by an embedded stack, which uses OSE as the real time operating system 400, is ported to the ARM7 CPU 313 and is available from Enea, Nytorps-vägen 5 B, Box 232, SE-183 23 Täby, Sweden.

In a second layer and based on the Bluetooth stack 508, a Bluetooth process 522 executes to perform most of the Bluetooth-oriented tasks and to alert the application software processes, when data is available. For instance, the Bluetooth process 522 is responsible for initialization of the Bluetooth hardware, and, more importantly, for performing inquiries to other available apparatuses when commanded from the inquiry management in the application software. As will be described in more detail later with reference to FIGS. 10 and 11, inquiry responses will be “filtered” (Blocked list), and the application software will be notified. Connection to another apparatus which has responded to the inquiry will be accepted after checking against the Blocked list. The Bluetooth process 522 will also handle the exchange of the “Who I am” profiles 213/217, the “Who I would like to meet” profiles 214/218, the additional personal information 215/219 and, of course, the unique apparatus-specific Bluetooth user-IDs 216/220 between the portable communication apparatus 101/201 and another apparatus, e.g. 203 in FIG. 2. Connections will be closed automatically when data has been exchanged or after a time out.

The RS232/USB driver 506 is required for program loading and loading of profiles, as completed in accordance with the user's desires and preferences, from the external computer 308. The driver interacts with a serial communication driver 520 and supports functionality for opening and closing the serial port (connector 307 in the preferred embodiment), as well as reading and writing data from/to this serial port.

The I2C driver 504 forms an interface towards peripheral equipment (such as EEPROM memory 311c, real time clock and AD converter). The driver has functionality for addressing a device, and writing and reading data to/from this device. An EEPROM driver 518 interacts with the I2C driver 504 and supports functionality for checksum handling, reading and writing data, byte addressable. A power monitor process 510 is a background process, which periodically checks the battery status in order to assure a sufficient operating voltage.

A display driver 516 supports basic functionality of the display, such as character output, pixel output, cursor positioning, clearing the display, backlight control, etc.

In addition, a flash memory driver (not shown in FIG. 5) is provided as an interface towards the flash memory 311a for program loading/updates. Various program loading modules are included in the base software (but not shown in FIG. 5), such as a loader for boot loading and application loading, a loader for the external computer 308, and a loader for application loading via Bluetooth and/or RS232/USB.

An I/O driver 502 forms a module for handling inputs and outputs, and includes functionality for configurating, reading and setting I/O pins. The I/O driver 502 interacts with a keyboard driver 514 and a LED/buzzer/vibrator driver 512. The keyboard driver 514 is provided for detecting and decoding a key 106, once it has been depressed on the keyboard 105, and for inserting an event in the main event queue 600 to alert the application software 402. The LED/buzzer/vibrator driver 512 forms an interface to the LED indicator 312c, the buzzer 312a and the vibrator 312b.

A self test module (not shown in FIG. 5) may be provided for performing hardware tests during system start-up. Errors will be reported to the application by inserting error events into the main event queue.

The base software also includes system start-up code that initializes and configurates the CPU 313.

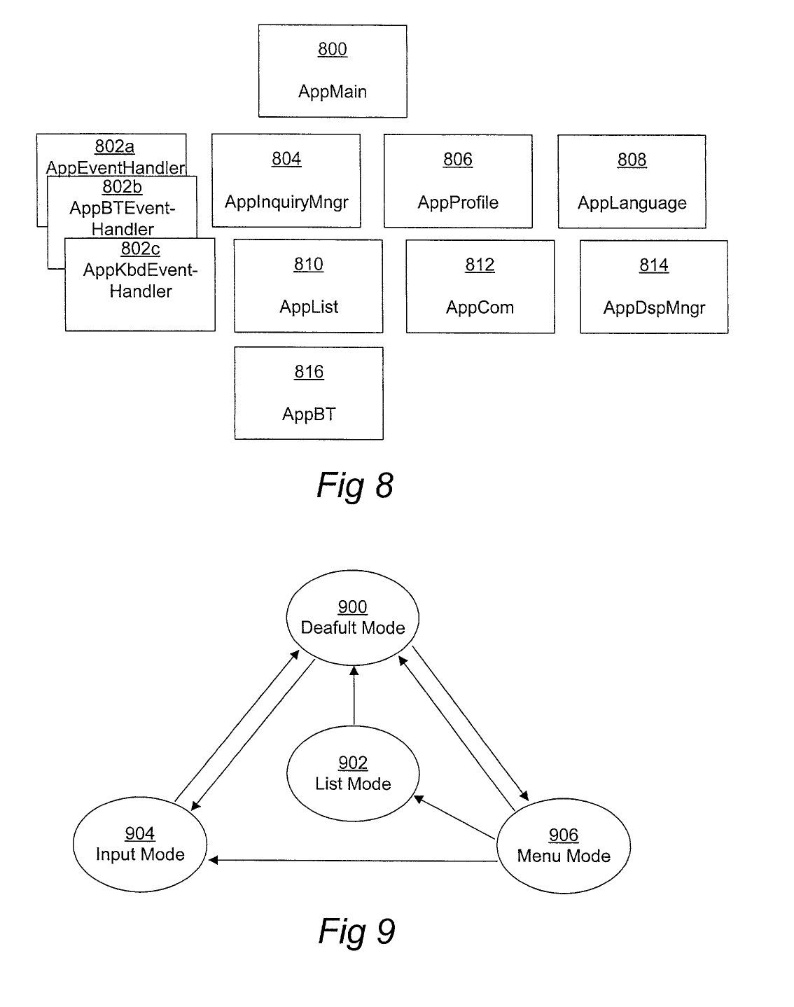

The application software 402 will now be described in more detail with reference to FIGS. 8 and 9. The application software 402 comprises various modules 800-816, which are responsible for different tasks, such as

Profile data management (editing, storing and loading of WIA profiles 213/217 and WIWLTM profiles 214/218).

Bluetooth functionality—inquiring for available apparatuses 203, 205, 207, connecting to an individual apparatus 203 and transfer of data 213-216/217-220 to/from this individual apparatus 203.

Match making process—analysis of the correlation between the received WIA and WIWLTM profiles 217-218 and the corresponding local profiles 213-214 stored in the apparatus 201 so as to investigate a potential match between users 202 and 204 of the apparatuses 201 and 203.

Additional communication services, such as chat and ask-questions functionality.

An AppMain module 800 implements the main application process, self test code and initialization code for the application software 402. It also contains a “worker thread” that performs system-related background tasks (such as EEPROM writing). This module also handles global data used in the system. Global data may for instance include chosen language for the user interface 314, power mode of the apparatus, etc.

An AppLanguage module 808 implements multi-language support for the portable communication apparatus 201. Via a menu selection in the graphical user interface (GUI), the user 202 may switch to another language. Each language-dependent resource (such as text strings for menus, help messages and error messages) will be declared as a vector with one entry for each supported language. Selecting a language is done by setting a pointer to the offset of the requested language in this vector.

An AppDspMngr module 814 is a display manager which implements a hierarchical menu system, popup-menus, popup message windows, list viewing functionality, etc., which are all part of the GUI.

An AppProfile module 806 implements functionality for user profile handling. As previously mentioned, for each user 201, 203, 205, 207 of the respective apparatus 202, 204, 206, 208 there will be defined a WIA (“Who I am”) profile, representing the user himself/herself, as well as a WIWLTM (“Who I would like to meet”) profile concerning a person that the user wishes to find.

Each profile will consist of a large number of parameters grouped into different categories. The layout (order) of the parameters will be fixed, and the layout definition (grouping, attribute texts, etc) will be saved in the flash memory 311a. The editable part (the actual parameter values as set by each user 202, 204) of each profile will be permanently saved in the EEPROM memory 311c and copied into the SRAM memory 311b upon application initialization 700. Moreover, when a remote apparatus 203 sends over its WIWLTM profile 218 and the Must-Match part of its WIA profile 217 to a local apparatus 201, the received profiles, too, will be placed in the SRAM memory 311b, to be processed and compared with the local profiles 213, 214 during the match-making process.

In an exemplifying but not limiting embodiment of the invention, each profile may include two categories of match-making parameters; Must-Match parameters and Query parameters. As the name implies, the Must-Match parameters are of crucial nature, in this exemplifying embodiment, and must be completely fulfilled for two persons, for there to be any chance at all for a match between them. The Query parameters are of “less importance”; they do not need to be completely fulfilled for two persons, but fulfilled up to a certain level, for a match. As an example, if a heterosexual man would like to meet a partner, the partner has to be a heterosexual or bisexual woman or there will be no match. Thus, “Gender and Sexual orientation” belong to the group of Must-Match parameters. However, if this man likes music and he would like to meet a partner who also likes music, there is a possibility for a match even with a partner who does not like music. Thus, “Listening to music” belongs to the group of Query parameters.

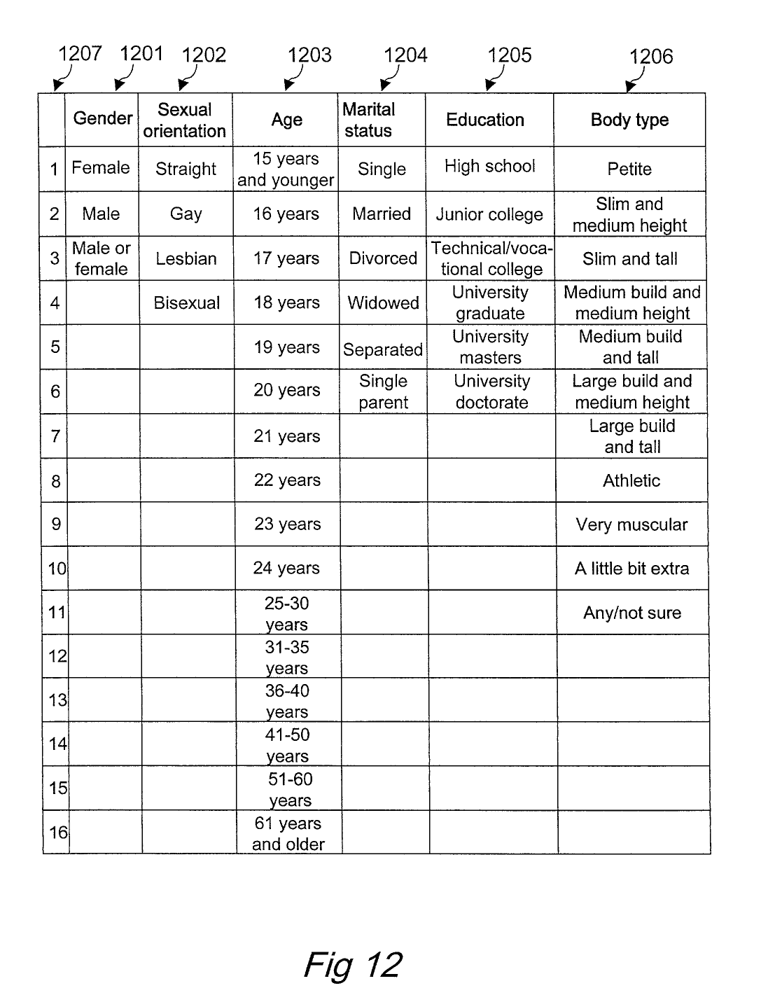

The Must-Match parameters may be stored in 4 bits and therefore hold a value from 0 to 15. The value represents a property which is specific for each Must-Match parameter. Some questions may have only a few properties (such as Gender), whereas other may have many properties. In the exemplifying but not limiting embodiment referred to above, and as shown in FIG. 12, the Must-Match parameters are: Gender (1201), Sexual orientation (1202), Age (1203), Merital status (1204), Education (1205) and Body type (1206). The possible values for the different Must-Match parameters 1201-1206 are shown in FIG. 12, together with the different 4-bit code values 1207 (in decimal form) for the respective parameter values.

The Query parameters may be considerably more numerous than the Must-Match parameters. Each Query parameter may have a value from 0 to 2 (decimal form), representing the possible answers “Agree”, “Disagree” and “Don't care” to a corresponding question associated with the respective Query parameter. More specifically, the possible answers are expressions stating how much a quality or an activity agrees with someone's personal interests. As an example, if the question concerns “Shopping” and the user loves shopping, the answer to the question in the user's WIA profile should, of course, be “Agree”. Moreover, if the user wants a partner who is also fond of shopping, the answer to the question in the user's WIWLTM profile should also be “Agree”. On the other hand, if the user does not care that much about the shopping interest of a potential partner, the answer to the question in the user's WIWLTM profile could instead be “Don't care”.

Other non-limiting examples of Query parameters are: Reading, Painting, Sewing, Watching TV, Aquariums, Surfing the Internet, Watching sports, Writing, and Gardening. Many more parameters are however possible.

Each user 202, 204, 206, 208 of a portable communication apparatus 201, 203, 205, 207 according to the present invention must personalize their WIA and WIWLTM profiles 213/217, 214/218 by inputting the information referred to above. In one embodiment, this is done by presenting aforesaid questions, one by one, on the display 104/304 and inviting the user to answer the questions by operating the keys 106 and the joystick 106′ on the keyboard 105/305. The additional personal information 215/219 will be completed in a corresponding manner. In an alternative embodiment, the user may instead view the questions on a CRT or LCD screen associated with the external computer 308 and complete the profiles 213/217, 214/218, as well as the additional personal information 215/219, by means of the computer keyboard. After completion, the information will be downloaded to the portable communication apparatus by means of the connector 107/307.

In the preferred embodiment, the entire WIWLTM profile 218 but only the Must-Match part of the WIA profile 217 are transmitted from a remote apparatus 203 to a local apparatus 201 during the match-making process. This has an advantage in terms of personal integrity; the values of the numerous Query parameters are kept secret within each apparatus. However, it is to be understood that no details concerning the format, disposition or contents of the match-making profiles are central or critical aspects of the present invention.

The analysis of the correlation between the WIA and WIWLTM profiles 217-218 received from another apparatus 203 and the corresponding local profiles 213-214 stored in the apparatus 201 may be performed by the AppProfile module 806 in different ways. In one embodiment, the analysis is divided into two steps, where the first step concerns the Must-Match parameters and the second step concerns the Query parameters but is only performed if the outcome of the Must-Match analysis is positive. More specifically, in the first step the Must-Match parameters of the WIA profile 213 associated with the user 202 are compared to the Must-Match parameters of the WIWLTM profile 218 associated with the user 204 of the other apparatus 203, and the result of the comparison is a first value of correlation. The first value of correlation, which may be a number between 0 and 1, is a measure of how well the user 202 matches the desires of the user 204; a value of 1 indicates a complete match, whereas a value of 0 indicates no match at all. Then, in a corresponding manner, the Must-Match parameters of the WIWLTM profile 214 associated with the user 202 are compared to the Must-Match parameters of the WIA profile 217 associated with the user 204 of the other apparatus 203, and the result of this comparison is a second value of correlation.

The first and the second value of correlation are then compared with a first and a second threshold value, respectively. If the first and second values of correlation meet or exceed the respective first and second threshold values, the users 202 and 204 match each other well enough regarding the Must-Match parameters, and the correlation analysis proceeds with the second step. On the other hand, if either of the first or the second value of correlation does not meet or exceed the first or second threshold value, respectively, then there is considered no match between the users 202 and 204, and the correlation analysis is terminated without performing the second step. In the preferred embodiment, the first and second threshold values are both equal to 1. Thus, the requirement for continuing with the second step of the correlation analysis, i.e. the step concerning the Query parameters, is that the users 202 and 204 match each other completely regarding the Must-Match parameters. The first and second steps of correlation analysis are performed in the corresponding manner in the other apparatus 203.

In the second analysis step, the Query parameters of the WIA profile 213 associated with the user 202 are compared to the Query parameters of the WIWLTM profile 218 associated with the other user 204. The result of the comparison is a third value of correlation between 0 and 1. The third value of correlation for the Query parameters corresponds to the first value of correlation for the Must-Match parameters. Thus, the third value of correlation is a final measure of how well the user 202 matches the desires of the user 204 (a corresponding fourth value of correlation will be calculated in the other apparatus 203, indicating how well the user 204 matches the desires of the user 202). As above, the third value of correlation is compared to a third threshold value in the apparatus 201 (and the fourth value of correlation is compared to a fourth threshold value in the apparatus 203). If the third value of correlation meets or exceeds the third threshold value, it is ultimately determined, in the apparatus 201, that there is a match between users 202 and 204. This does not necessarily mean that the successful match is mutual, since the third and fourth threshold values can be chosen individually by the users 202 and 204. A successful match may be alerted to the user by a visual, audible or tactile indication through the user interface 314.

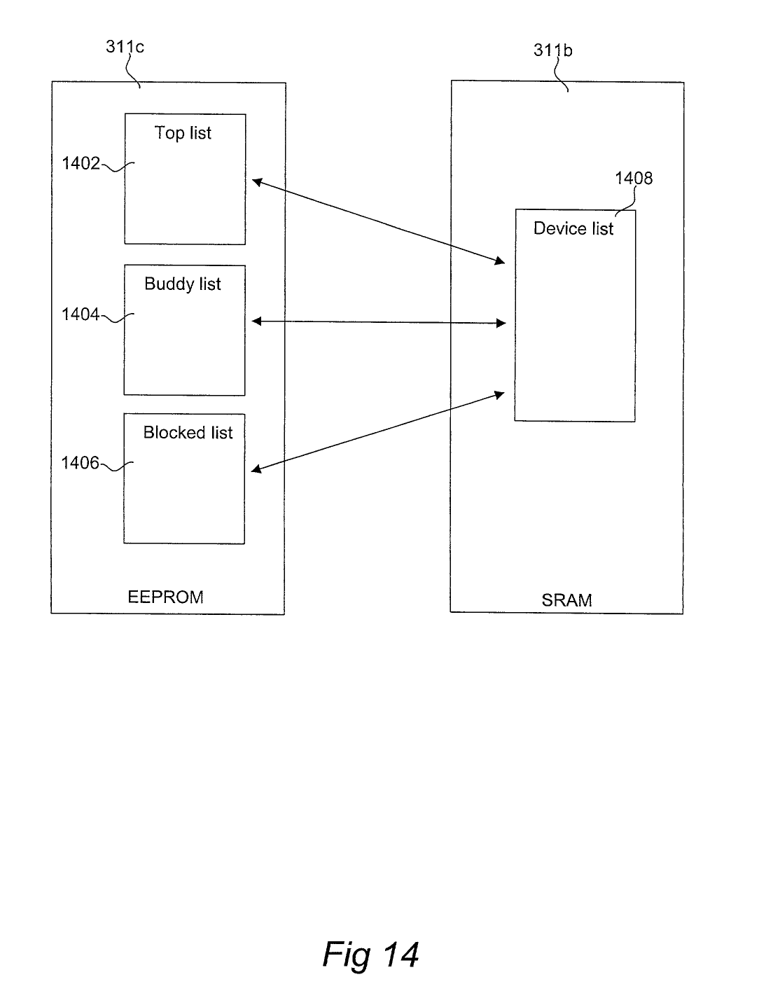

An AppList module 810 supports several lists, which are indicated in FIG. 14: A Top list 1402, a Buddy list 1404, a Blocked list 1406 and a Device list 1408. The lists 1402-1406 are stored in non-volatile memory (EEPROM memory 311c), but the contents thereof are merged into the Device list 1408 upon application initialization 700. The Device list 1408 is temporarily stored in volatile work memory (SRAM memory 311b) for optimum performance, and the contents thereof is lost when the apparatus 201 is turned off. Therefore, during operation, any changes made to a record in the Device list 1408 will automatically be written back to the appropriate permanent list 1402, 1404 or 1406 by the AppList module 810. Thus, in a sense, the Device list 1408 resembles a cache memory.

The Top list 1402 is a high score list which stores the X best historical matches in the apparatus 201, so that the user 202 can access them at any time. X may for instance be 10, 50 or 100; the actual value will be chosen in view of an actual application and is not critical to the invention. For each match on the Top list 1402, the following data may be stored:

| Data | Description |
|---|---|
| Apparatus-specific | See e.g. Bluetooth address 220 of the |
| user-ID | remote apparatus 203 in FIG 2. |
| User-friendly name | See 1304 in FIG 13. |
| Contact information | See 1302 in FIG 13. |
| Correlation factor | The third value of correlation, |
| | calculated as described above. |

The Buddy list 1404 allows the user 202 to store links, in the form of apparatus-specific user-IDs, to other apparatuses 203, 205, 207 belonging to friends, family members, etc. The Buddy list 1404 may have the following format:

| Data | Description |
|---|---|
| Apparatus-specific | See e.g. Bluetooth address 220 of |
| user-ID | the remote apparatus 203 in FIG 2. |
| User-friendly name | See 1304 in FIG 13. |
| Class of device | Identifies the type of device (appa- |
| | ratus 203, mobile phone, PDA, etc) |

A remote apparatus ID may be added onto the Buddy list 1404 either by copying that record from the Top list 1402 or by creating a record manually through the GUI.

Once an apparatus which is represented in the Buddy list 1404 comes within range and is detected through the inquiry management, the presence thereof will be alerted to the user 202 through the GUI. Moreover, in one embodiment, the user 202 may browse the Buddy list 1404 through the display 304 of the GUI, and each Buddy list record may have a graphical indication which shows whether that apparatus is within range and, even, how close it is.

The Blocked list 1406 allows the user 202 to prevent further communication from another apparatus 203, 205 or 207. This may be useful for stopping involuntary harassments, spam messages through the ask-questions functionality, etc. Thus, the present apparatus 201 will not reply to any Bluetooth communication from an apparatus which is represented in the Blocked list 1406.

The list may have the following format:

| Data | Description |
|---|---|
| Apparatus-specific | See e.g. Bluetooth address 220 of the |
| user-ID | remote apparatus 203 in FIG 2. |
| User-friendly name | See 1304 in FIG 13. |

A remote apparatus may be added onto the Blocked list 1406 either by copying that record from the Top list 1402 or by creating a record manually through the GUI.

The Device list 1408 is a general list for keeping track of available Bluetooth devices, including other portable communication apparatuses 203, 205, 207. This list will be used from several processes and tasks in the base software 404 and application software 402. The list may have the following format:

| Data | Description |
|---|---|
| Apparatus-specific | E.g. Bluetooth address. |
| user-ID | |
| User-friendly name | See 1304 in FIG 13. |
| Contact information | See 1302 in FIG 13. |
| Class of device | Identifies the type of device (appa- |
| | ratus 203, mobile phone, PDA, etc) |
| Status data | Indicating whether the device: |
| | Is in Buddy list |
| | Is in Top list |
| | Is in Blocked list |
| | Has responded to inquiry |
| | Has exchanged profiles (= matched; |
| | including value of correlation) |
| | Could not exchange profiles |

The contents of the Top list 1402, Buddy list 1404 and Blocked list 1406 can be accessed by the user through the GUI of the apparatus at any time. More specifically, the user may select a certain user-friendly name in either the Top list 1402 or the Buddy list 1404 and try to initiate a chat session by addressing the apparatus-specific user-ID associated with that user-friendly name. Moreover, a question may be broadcasted to users that are represented in the Top list 1402 and Buddy list 1404, or to devices that are represented in the Device list 1408 but not in the Top list 1402/Buddy list 1404—for instance remote apparatuses which the current apparatus has not exchanged profile data with.

To avoid “spamming” of incoming questions, in one embodiment of the portable communication apparatus 201 the user may select different levels of receptivity of incoming questions: ALL (allowing incoming questions from all available remote apparatuses), ALL BUT BLOCKED (refusing questions from blocked remote apparatuses but allowing questions from other apparatuses) or NONE (refusing questions from any remote apparatus).

An AppEventHandler module 802a implements the event handling shown in FIGS. 6 and 7 and includes an AppBTEventHandler module 802b as well as an AppKbdEventHandler module 802c. The module 802c handles keyboard events and implements a state machine shown in FIG. 9, where different key stroke sequences will set the portable communication apparatus 201 into different operating modes and bring up different menus (screens) on the display 304. In a default mode 900, the state machine will poll the keyboard 304, waiting for a key press. Once a key has been pressed, a menu mode 906 will be entered so as to track a menu selection on the GUI presented on the display 304. Depending on the menu selection either some functionality will be performed or the operation mode will be changed (e.g. to a text input mode 904 or to a list mode 902). A time out function will reset the keyboard handler and the display, if no key has been pressed within a predetermined time (such as 30-60 seconds). The state machine may also include a message mode (not shown in FIG. 9), used when waiting for user acknowledge after presentation of a message window on the display 304 to the user.

The AppBTEventHandler module 802b is responsive to events 530 supplied by the Bluetooth process 522 in the base software 404. These events may include: a BT_FOUND_DEVICE event to indicate that another apparatus 203 has responded to an inquiry and that, therefore, the present apparatus should proceed with the match-making procedure; a BT_MATCH_REQUEST event to indicate that another apparatus 203 has requested a match, i.e. that profile data is available; and a BT_CHAT_REQUEST event to indicate that another apparatus 203 has requested a chat session.

Upon BT_FOUND_DEVICE, the following will take place. First, a check will be made whether the apparatus-specific user-ID 220 of the other apparatus 203 is present in the Buddy list 1404—if so, the user 202 will be alerted. Otherwise it will be checked whether user-ID 220 is already in the Top list 1402 or the Blocked list 1406, or is already marked as matched in the Device list 1408. If none of these alternatives applies, the apparatus 201 will connect to the other apparatus 203 and exchange profile data 213-215, 217-219.

A BT_MATCH_REQUEST event occurs when the apparatuses have exchanged user profiles. The connect and exchange are handled by the BT process 522 in the base software 404. Then the correlation analysis described above is performed, and the outcome is stored in the appropriate lists (e.g. Top list 1402, Device list 1408).

When a BT_CHAT_REQUEST event is generated in response to a request for a chat session made by the user 204 of another apparatus 203, the user 202 of the present apparatus 201 must accept the invitation before the chat session can start. If no acceptance is given, the apparatus 201 will provide a negative response to the other apparatus 203, and the session will be terminated prematurely. Otherwise, if an acceptance is given, a positive response will be given to the other apparatus 203. The AppKbdEventHandler (keyboard handler) 802c and the AppDspMngr (display manager) 814 will be forced into a chat mode and will remain in this mode, until the chat session is terminated either by one of the users 201, 203 or upon a timeout.

An AppInquiryMngr module 804 cooperates with the Bluetooth process 522 in the base software 404, as well as with an AppBT module 816 and an AppCom module 812, to handle the general inquiry management for the apparatus 201, as is illustrated in more detail in FIG. 10, and also to handle the power management of the apparatus 201, as is illustrated in more detail in FIG. 11. Within the context of this invention, inquiry means repeatedly searching for other apparatuses 203, 205, 207 that are within range of the present apparatus 201. Generally, the inquiry handling involves two modes: a scan mode in which the apparatus 201 will be responsive to inquiries from other apparatuses but will itself not make any inquiries, and an inquiry mode in which the present apparatus 201 will transmit inquiry messages in the form of radio signals through its Bluetooth interface. The frequency and duration of the scan mode in relation to the inquiry mode may be set by the user 202 or may be handled automatically by the apparatus 201, as will be described in more detail with reference to FIG. 11.

The inquiry mode may, e.g., last for a maximum period of 5 seconds every 30 seconds, but these values are not critical to the invention, as will be more apparent from the description of FIG. 11.

As seen in FIG. 10, after an initializing step 1000, the inquiry mode 1002 will be entered at a certain interval, as described above. In steps 1024-1030, inquiry events will be generated and intercepted by the BT process 522 of the base software 404, which in turn will form and transmit the actual inquiry messages through the radio module 309 and the antenna 310. Inquiry generation will continue until either a predetermined number of responses have been received, at 1004, or a timeout occurs (after, e.g., 5 seconds), as seen at 1006.

Then, for each responding apparatus 203, etc., the apparatus-specific user-ID 220 and also its Class of Device will be determined in step 1008. In steps 1010 and 1012, the Device list 1408 is checked to see whether the responding apparatus is already represented in the list. If so, the responding apparatus is marked as present in the Device list 1408, and if the Device list 1408 indicates that match-making (exchange of profiles+correlation analysis) has already been performed with this responding apparatus, the user 202 is alerted in case the user-ID of the responding apparatus 201 is indicated as Buddy in the Device list 1408. Moreover, a check is made to see if the responding apparatus 203 is indicated as Blocked, wherein further communication will be prevented. Then, the execution proceeds to end at 1022.

Otherwise, the present apparatus 201 tries to exchange profiles with the responding apparatus in step 1014, or at least obtain the user-friendly name 1304 in step 1018. If this for some reason is not successful (perhaps because the responding apparatus has moved away from and out of range of the present apparatus 201), the execution ends at 1022.

If profile data (shown in FIG. 13) for the responding apparatus was successfully received in the present apparatus 201, the received data —including the WIA (Must-Match parameters only) and WIWLTM profiles 217, 218 of the responding apparatus 203 as well as its attached additional personal information 219—is stored in memory 311b. Then, the correlation analysis is performed in the manner previously described. The calculated third value of correlation is checked against aforesaid threshold value to see if the responding apparatus 203 qualifies as a match. The user 202 is duly alerted, if appropriate, using any of the standard ways of alerting, or alternatively by playing the responding user's personal ring signal 1308, if available. If the calculated third value of correlation qualifies for entry into the Top list 1402, a record in the Device list 1408 is marked accordingly. If a question was attached in the text field 1306 of the received profile data, this question is displayed on the display 304.

If the user 202 changes the information in the apparatus 201 (e.g., the WIA profile 213, the WIWLTM profile 214 or the additional personal information 215), all remote apparatus entries in the Device list 1408 will be “unmarked” in terms of the indication in the status data as to whether profile exchange has already been performed with the respective remote apparatus. Consequently, the apparatus 201 will try to reconnect to all available remote apparatuses, attempting to exchange the updated data.

In one embodiment, the status data in the Device list 1408 holds information reflecting when a particular remote apparatus 203, 205, 207 last responded to an inquiry. To this end, a counter included in the status data will be set to a predetermined initial value every time the particular remote apparatus responds to an inquiry. Then, each time the particular remote apparatus does not respond to an inquiry, the counter value is decreased. A counter value larger than zero indicates that the particular remote apparatus was recently present and may, in fact, still be present and should be available for, e.g., chat attempts. On the other hand, a counter value which has reached zero indicates that the particular remote apparatus is no longer present—maybe because the user thereof has moved away from the user of the current apparatus 201. The value of the counter will thus be an indication of how close the particular remote apparatus is, and/or the likelihood of a successful chat session. The counter will allow improved opportunities to stay in contact with apparatuses on the Buddy list 1404 while using shorter inquiry mode. A shorter inquiry mode will in turn be advantageous in terms of power consumption.

A power handling method according to the preferred embodiment will now be described with reference to FIG. 11. Since the portable communication apparatus 201 operates on a limited battery power, it is important not to use more power than necessary. Power optimization is also an important issue for minimizing the disturbances caused upon other neighboring apparatuses 203, 205, 207. Power optimization is obtained thanks to the invention by varying the following parameters:

A) The time between each inquiry mode.

B) The duration of each inquiry mode.

C) The output power of the radio module 309.

Power optimization is also obtained by identifying, for each responding apparatus 203 within range, if it is a new apparatus or an already known. Having a Device list 1408 with unique user-IDs makes it possible to identify and automatically adjust to a number of different situations:

Being in a very crowded area: Decrease power and inquiry interval.

Changing to a less crowded area: Adjust to normal inquiry interval and power.

Being left at home by mistake (constantly, the same apparatuses will respond to inquiries): Decrease power to minimum.

Picked up and when contacted, resume to a normal inquiry interval and power.

When all apparatuses within low power range are contacted, increase the power to find new units.

When running low on battery, increase inquiry interval and decrease output power.

More specifically, as shown in FIG. 11, the power management procedure 1100 starts at 1102 by retrieving the number of new apparatuses discovered during inquiry mode. If, in 1104, this number is found to be 0, it is checked at 1116 whether the current output power is at maximum level. If so, a time constant which sets the inquiry interval (i.e. the time between subsequent inquiry modes) is increased at 1120, otherwise the output power is increased at 1118. The time constant may alternatively relate to the duration of each inquiry mode. Following this, a check for low battery level is done at 1122. If it is found to be low, the output power is set low, and the time constant is set to maximum, in step 1124. Otherwise, the execution ends at 1126.

If, on the other hand, the number of new apparatuses discovered during inquiry mode was found be at least 1 in step 1104, it is checked at 1106 whether this number is in fact larger than a first limit X. If the number is found not to exceed X, the output power is maintained at its current level and the time constant is set to its normal value in step 1114. However, if the number exceeds X, it is checked at 1108 whether it also exceeds a second limit Y, where Y>X. If so, the output power is decreased and the time constant is set to low in step 1110. If not, the output power is decreased and the time constant is set to normal in step 1112. After steps 1114, 1112 and 1110 follows the low battery check at 1122, as already described.

Additionally, an inactivity check is made at 1101. If no new apparatus has appeared, no apparatus has disappeared and no inquiries have been received during a predetermined time t_{long}, the output power is set to low and the time constant is set to maximum.

In the preferred embodiment the apparatus can emit different types of alerts according to the user's choice. For example, the alert can be the user's favorite love song or some other audible signal which allow for two users to find each other directly by match, by simply tracking the sound. A more discrete type of alert is a visual one, such as an indication in the display or a flashing lamp on the apparatus. An even more discrete alert is a perceptible one, such as a vibration which can only be sensed by the user.

In the preferred embodiment described above, all apparatuses 201, 203, 205, 207 communicate in a point-to-point manner over the Bluetooth interface (i.e., one sender communicates with one receiver at a time). An alternative embodiment, however, uses a broadcast functionality which is available in Bluetooth and according to which data is transmitted to several receivers simultaneously in a piconet consisting of one master device and up to seven slave devices. This alternative is advantageous if large data volumes are to be transmitted. The alternative embodiment may operate in the following manner:

The master device makes an inquiry.

All available devices respond to the master device.

The master device forms a piconet of slave devices (maximum seven) from the ones of the respondents that data has not previously been exchanged with.

The master device sends its profile data to all slave devices in the piconet thus formed.

The master device requests profile data from each slave device sequentially.

If the data payload is large, the formed piconet could sequentially switch the role as master device between the remaining slave devices, and then perform the data broadcast:

A master device #1 makes an inquiry.

All available devices respond to the master device.

The master device forms a piconet of slave devices (maximum seven) from the ones of the respondents that data has not previously been exchanged with.

The master device sends its profile data to all slave devices in the piconet thus formed.

The master device then changes roles with a first slave device.

The new master device #2 sends its profile data to all slave devices in the piconet.

The new master device #2 then changes roles with a second slave device.

The new master device #3 sends its profile data to all slave devices in the piconet.

Alternatively, if also the slaves devices can send broadcast to all other members in the piconet:

The master device makes an inquiry.

All available devices respond to the master device.

The master device forms a piconet of slave devices (maximum seven) from the ones of the respondents that data has not previously been exchanged with.

The master device sends its profile data to all slave devices in the piconet.

The first slave device sends its profile data to all other members of the piconet.

The second slave device sends its profile data to all other members of the piconet.

The third slave device sends its profile data to all other members of the piconet.

The apparatus according to the present invention may, for example, be realized as a separate, stand-alone unit, or may alternatively be included in, or combined with, a mobile terminal for a telecommunications network, such as GSM, UMTS, GPS, GPRS or D-AMPS, or another portable device of existing type, such as a PDA or a palmtop computer.

The invention has mainly been described above with reference to a preferred embodiment. However, other embodiments than the one disclosed above are equally possible within the scope of the invention, as defined by the appended patent claims. All terms used in the claims are to be interpreted according to their ordinary meaning in the technical field, unless explicitly defined otherwise herein. All references to “a/an/the [element or step]” is to be interpreted openly as referring to at least one instance of said element or step. The steps of the methods described herein do not have to be performed in the exact order disclosed, unless explicitly specified.

1. A portable communication apparatus for match-making with a plurality of remote communication apparatuses, said portable communication apparatus comprising:
memory means, wherein said memory means is adapted to store first match-making data associated with said portable communication apparatus;
a transceiver, wherein said transceiver is adapted for communication with an individual one of said remote communication apparatuses across a wireless link, so as to receive second match-making data associated with said individual remote communication apparatus, said wireless link being based on an apparatus-specific identity of said portable communication apparatus as well an apparatus-specific identity of said individual remote communication apparatus;
a processing device, wherein said processing device is adapted to perform a correlation analysis between said first match-making data and said second match-making data and—in case a result of said correlation analysis indicates a match between said portable communication apparatus and said individual remote communication apparatus—provide an alert to a user of said portable communication apparatus;
wherein the apparatus-specific identity of said portable communication apparatus, the apparatus-specific identity of said individual remote communication apparatus as well as the apparatus-specific identities of other ones of said remote communication apparatuses are all unique.

2. A portable communication apparatus as in claim 1, wherein said processing device is further adapted to record, in said memory means, the respective apparatus-specific identities for at least some of the apparatuses among said plurality of remote communication apparatuses, that said portable communication apparatus has previously communicated with.

3. A portable communication apparatus as in claim 2, wherein an indication is stored, for each of the apparatus-specific identities recorded in said memory means, as to whether match-making data has already been received from the respective remote communication apparatus.

4. A portable communication apparatus as in claim 3, further adapted to refrain from receiving said second match-making data from said individual remote communication apparatus, if the apparatus-specific identity thereof is already recorded in said memory means and said indication indicates that said second match-making data has already been received.

5. A portable communication apparatus as in claim 4, further comprising a user interface for allowing said user to update said first match-making data, wherein said apparatus is adapted, once said user has updated said first match-making data, to reset the indication for each of the apparatus-specific identities recorded in said memory means to a state which represents that no match-making data has been received from the respective remote communication apparatus.

6. A portable communication apparatus as in claim 2, wherein said memory means is further adapted to store a list of preferred apparatus-specific identities, the apparatus being adapted to scan for remote communication apparatuses within reach, to determine the apparatus-specific identity of each such apparatus and to alert said user, if the apparatus-specific identity of any apparatus within reach is present in the list of preferred apparatus-specific identities.

7. A portable communication apparatus as in claim 2, wherein said memory means is further adapted to store a list of unwanted apparatus-specific identities, the apparatus being adapted to scan for remote communication apparatuses within reach, to determine the apparatus-specific identity of each such apparatus and to prevent further communication with any apparatus within reach, if the apparatus-specific identity thereof is present in the list of unwanted apparatus-specific identities.

8. A portable communication apparatus as in claim 2, wherein said memory means is further adapted to store a top list of apparatus-specific identities for remote apparatuses which have resulted in good matches with said portable communication apparatus.

9. A portable communication apparatus as in claims 6, 7 and 8, wherein the contents of at least one of said list of preferred apparatus-specific identities, said list of unwanted apparatus-specific identities or said top list of apparatus-specific identities are accessible to said user through a user interface of said portable communication apparatus.

10. A portable communication apparatus as in claims 6, 7 and 8, wherein the contents of at least one of said list of preferred apparatus-specific identities, said list of unwanted apparatus-specific identities or said top list of apparatus-specific identities are stored in non-volatile memory.

11. A portable communication apparatus as in claim 9, further adapted to allow said user to enter a text message through said user interface and send the text message to at least one individual remote apparatus by selecting a corresponding entry in said list of preferred apparatus-specific identities or said top list of apparatus-specific identities.

12. A portable communication apparatus as in any one of the preceding claims, being embodied in or as a mobile terminal for a telecommunications network.

13. A portable communication apparatus as in any one of claims 1-11, being embodied in or as a Portable Digital Assistant or a palmtop computer.

14. A portable communication apparatus as in any one of claims 1-11, wherein said transceiver is adapted to communicate in accordance with the Bluetooth specification.

15. A power preservation method for a portable communication apparatus according to claim 1, comprising the steps of
transmitting, through said transceiver, inquiries for remote apparatuses within reach;
receiving responses from remote apparatuses which have received said inquiries;
evaluating the number of responses received; and
in response to said evaluating step, adjusting at least one of a duration of said transmitting step, a time interval between subsequent transmitting steps, and an output power of said transceiver.

16. A method as in claim 15, wherein said evaluating step is performed by counting the apparatus-specific identities of the responding remote apparatuses.
